(19) United States
(12) Patent Application Publication
(10) Pub. No.: US 2004/0113388 A1
(43) Pub. Date: Jun. 17, 2004

(54) Vehicle having adjustable footrest apparatus

(75) Inventors: Steven R. Porter, Burnsville, MN (US); Dale A. Stover, Plymouth, MN (US)

Correspondence Address: MUETING, RAASCH & GEBHARDT, P.A., P.O. BOX 581415, MINNEAPOLIS, MN, 55458, US

(73) Assignee: The Toro Company, Bloomington, MN

(21) Appl. No.: 10/316,490

(22) Filed: Dec. 11, 2002

(51) Int. Cl. B62H 1/00

(52) U.S. Cl. 280/291

(57) ABSTRACT

A footrest apparatus for use with a riding ground maintenance vehicle, e.g., a zero-radius-turning lawn mower. In one embodiment, at least a footrest surface of the footrest apparatus is adjustable along a direction parallel to a longitudinal axis of the mower. The footrest surface provides an adjustable resting position for the operator's feet during lawn mower operation.

### TECHNICAL FIELD

The present invention relates generally to ground maintenance vehicles such as zero-radius-turning (ZRT) mowers and, more particularly, to such vehicles having a footrest apparatus, wherein the footrest apparatus includes one or more footrest surfaces that are adjustably positionable relative to the vehicle.

### BACKGROUND

Traditional riding mowers, e.g., those typically having four wheels wherein the front wheels are conventionally steerable, are in common use by homeowners and professionals alike. However, for lawns having numerous obstacles, tight spaces, and/or intricate borders, riding mowers having zero-radius-turning (ZRT) capability are often preferred. As the name implies, “ZRT” generally indicates a vehicle having a very tight minimum turning radius, i.e., a vehicle that is highly maneuverable.

Most ZRT riding mowers have one or more drive wheels located on each side of the mower. The drive wheels are typically independently powered, e.g., by separate hydraulic motors, so that, while a drive wheel on a first side of the mower may rotate in a first direction at a first speed, the drive wheel on the opposite side may rotate in the same or different direction at the same or different speed. Rotating one drive wheel for forward motion while simultaneously slowing, stopping, or reversing rotation of the drive wheel on the opposite side, causes the mower to turn. At the extreme, the mower may spin generally about a vertical axis located between the respective drive wheels.

To control the independently powered drive wheels, ZRT mowers typically utilize one or more hand controls. For example, some mowers may include a joystick that, when manipulated in a particular manner, separately controls the rotational speed and direction of each drive wheel.

An at least equally common control system found on ZRT mowers includes independent left and right drive control levers that control the drive wheel(s) on the left and right sides of the mower, respectively. During operation, incremental forward movement of either drive control lever (from a neutral position) results in an incremental increase in rotational speed of the respective drive wheel in a forward direction. Similarly, incremental rearward movement of either drive control lever (from a neutral position) results in an incremental increase in rotational speed of the respective drive wheel in a rearward direction. Thus, by independently moving each drive control lever, the direction and speed of the drive wheel(s) on each side of the mower may be separately controlled.

While the drive control levers offer effective steering and speed control for ZRT mowers, drawbacks do exist. For example, during operation, the operator may desire to reposition himself or herself on the seat, e.g., push himself rearwardly against the back of the seat, to maintain comfort. With a conventional mower utilizing a generally fixed steering wheel, the operator may merely grasp the steering wheel and pull/push against it while pushing his or her body rearwardly with his or her feet. However, pulling (or pushing) against the drive control levers of a ZRT mower merely results in repositioning the drive control levers. That is, rather than counteracting the force exerted by the operator, the levers move to a new position, which undesirably changes the speed and/or direction of the mower.

As a result, to reposition himself or herself within the seat of a ZRT mower, the operator generally relies mainly on his or her feet to impart any rearward force necessary to reposition the body. To assist with imparting this rearward force, some known ZRT mowers provide an inclined foot resting surface. The inclined surface provides not only a more comfortable foot position, but also a surface having a vertical component against which the operator's feet may push.

However, the position of the inclined foot resting surface for these known ZRT mowers is fixed, relative to the frame, based upon the leg and body size of an average operator. Thus, operators who are either shorter or taller than average may find the position of the foot resting surface less than desirable.

### SUMMARY

To address these and other drawbacks, the present invention provides a ground maintenance vehicle, e.g., a zero-radius-turning lawn mower, having a footrest apparatus that may be adjustably located relative to the vehicle. Thus, the lawn mower may be configured to comfortably conform to operators of varying size.

In one embodiment, a zero-radius-turning riding vehicle is provided. The vehicle includes a seat attached to a frame of the vehicle, and one or more controls associated with the vehicle and located proximate the seat. The one or more controls are operable to control one or both of speed and direction of the vehicle. A footrest apparatus coupled to the frame is also provided and includes at least one footrest surface. A position of the at least one footrest surface is adjustable relative to the vehicle.

In another embodiment, a zero-radius-turning riding lawn mower is provided and includes a seat attached to a frame of the lawn mower, and one or more controls operatively coupled to the frame. The one or more controls are operable to control one or both of speed and direction of the lawn mower. A footrest apparatus coupled to the frame and including at least one footrest surface is also provided. A position of the at least one footrest surface is adjustable relative to the frame.

In yet another embodiment, a zero-radius-turning riding lawn mower is provided. The lawn mower includes a frame supported in rolling engagement with a ground surface, and an operator's seat attached to the frame. One or more control levers are also provided and operatively coupled to the frame. The one or more control levers are operable to control one or both of speed and direction of the lawn mower relative to the ground surface. A footrest apparatus is also included. The footrest apparatus is attachable to the frame at more than one location along a direction parallel to a longitudinal axis of the lawn mower.

In still yet another embodiment, a zero-radius-turning riding lawn mower is provided and includes a frame supported in rolling engagement with a ground surface, and a seat attached to the frame. One or more control levers are also provided. The one of more control levers are operatively coupled to the frame and positioned near the seat. The one or more control levers are operable to control one or both of speed and direction of the lawn mower relative to the ground surface. At least one footrest surface operable to securely attach to the frame at two or more locations along a direction parallel to a longitudinal axis of the lawn mower is also provided.

In yet another embodiment, a zero-radius-turning riding lawn mower is provided and includes a seat attached to a frame of the lawn mower. One or more controls operatively coupled to the frame are also included. The one or more controls are operable to control one or both of speed and direction of the lawn mower. Further, a footrest apparatus including at least one footrest surface is included, wherein one or both of the footrest apparatus and the at least one footrest surface are removably attachable to the lawn mower.

The above summary is not intended to describe each embodiment or every implementation of the present invention. Rather, a more complete understanding of the invention will become apparent and appreciated by reference to the following detailed description and claims in view of the accompanying drawing.

### BRIEF DESCRIPTION OF THE VIEWS OF THE DRAWING

The present invention will be further described with reference to the views of the drawing, wherein:

FIG. 1 is a perspective view of a zero-radius-turning (ZRT) mower having a footrest apparatus in accordance with one embodiment of the present invention;

FIG. 2 is a top plan view of the ZRT mower of FIG. 1 with the cutting deck removed for clarity;

FIG. 3 is an enlarged perspective view of the ZRT mower of FIG. 1 illustrating repositioning of the footrest apparatus; and

FIG. 4 is a side elevation view of the ZRT mower of FIG. 1 illustrating the footrest apparatus in multiple positions.

### DETAILED DESCRIPTION OF EXEMPLARY EMBODIMENTS

In the following detailed description of exemplary embodiments, reference is made to the accompanying figures of the drawing which form a part hereof, and in which are shown by way of illustration specific embodiments in which the invention may be practiced. It is to be understood that other embodiments may be utilized and structural changes may be made without departing from the scope of the present invention.

Generally speaking, the invention described herein is directed to a ride-on ground maintenance vehicle having a footrest or footrest apparatus. The footrest apparatus may be adjustably attachable to the vehicle, e.g., to a vehicle frame, such that a position of at least a footrest surface of the footrest apparatus is adjustable relative to the vehicle. The phrase “adjustably attachable” is used herein to indicate that the footrest apparatus may be securely coupled to the vehicle at more than one operator-selectable location, or at a single location that permits at least the footrest surface of the footrest apparatus to be securely positioned at more than one operator-selectable location. Movement of the footrest surface is preferably accomplished without the need for tools or complex operator procedures.

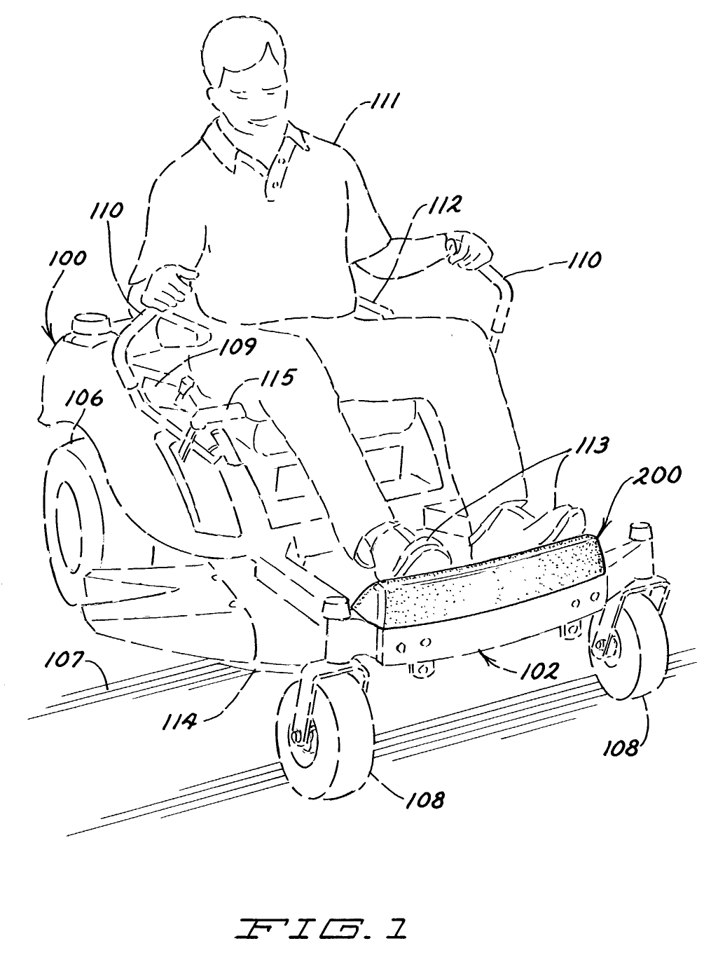

FIG. 1 illustrates a footrest apparatus 200 in accordance with one embodiment of the present invention as it may be incorporated on a self-propelled, ground maintenance vehicle, e.g., a zero-radius-turning (ZRT) riding lawn mower 100 (also referred to herein simply as a “mower”). While the invention is herein described with respect to riding ZRT mowers, those of skill in the art will realize that the invention is equally applicable to other mowers, and to other ground traversing vehicles, especially those having ZRT capability, e.g., all terrain vehicles, skid-steer loaders, and other construction/excavation vehicles.

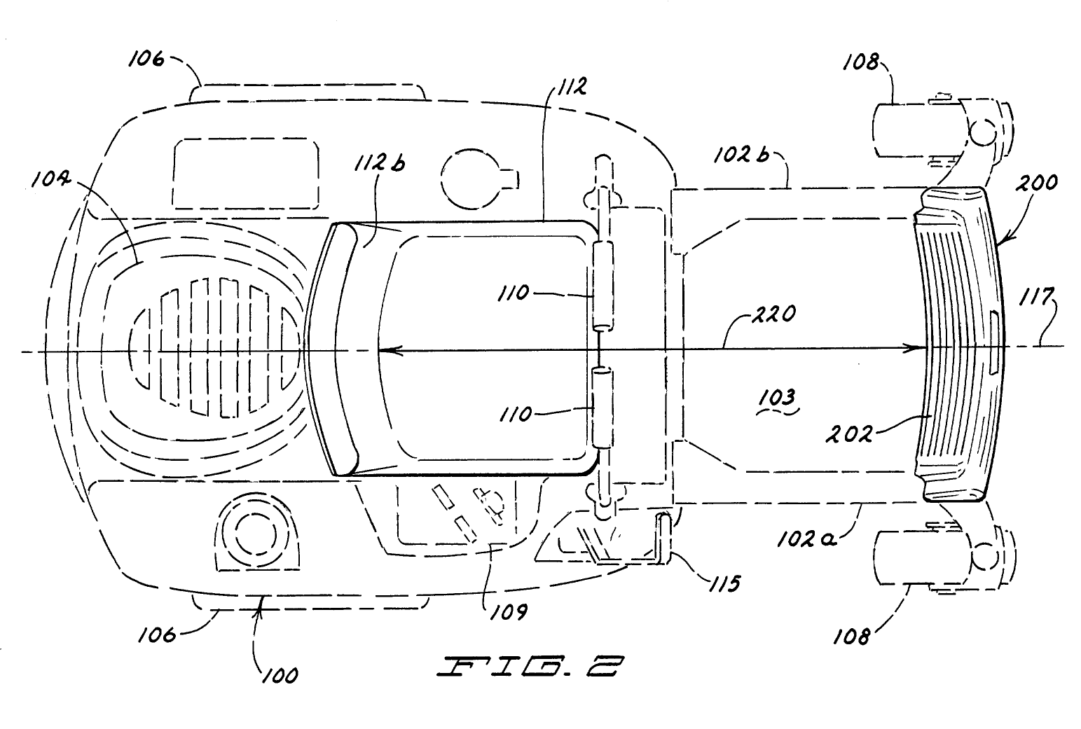

While the general mower configuration is not central to the invention, it is briefly described below. FIGS. 1 and 2 clearly illustrate the mower 100 having a frame 102 supporting a prime mover, e.g., internal combustion engine 104 (see FIG. 2). A left and a right ground engaging drive wheel 106 (only right wheel shown in FIG. 1) may be rotatably coupled to left and right sides of a rear portion of the mower 100, respectively. The drive wheels 106 may be independently powered by the engine 104 (e.g., via one or more hydraulic motors, transmissions, or the equivalent) so that the drive wheels 106 may propel the mower 100 along a ground surface 107 during operation.

One or more controls, e.g., left and right drive control levers 110 (shown displaced outwardly for operator ingress/egress in FIG. 1, and drawn inwardly for operation in FIG. 2) are also provided. The drive control levers 110 are generally pivotally coupled to the frame 102 such that they may pivot forwardly and rearwardly under the control of an operator 111 sitting in an operator's seat 112. The seat 112 may be adjustably attached to the frame 102, e.g., it may be adjustable at least in a direction parallel to a longitudinal axis 117 of the mower 100, to provide comfortable positioning of the operator's torso relative to the drive control levers 110.

The drive control levers 110 are operable to independently control speed and direction of the respective drive wheels 106 via manipulation of the mower's drive system as is known in the art. For example, incremental forward movement (e.g., pivoting about a transverse horizontal axis) of the left (or right) drive control lever 110 (from a neutral position) results in an incremental increase in rotational speed of the left (or right) drive wheel 106 in a forward direction. Similarly, incremental rearward movement of the left (or right) drive control lever 110 (from a neutral position) results in an incremental increase in rotational speed of the left (or right) drive wheel 106 in a rearward direction. While illustrated herein as incorporating separate drive control levers 110, other controls, e.g., single or multiple joysticks or joystick-type levers, may also be used without departing from the scope of the invention.

A pair of front swiveling caster wheels 108, connected to forwardly extending frame rails 102a and 102b, support a front portion of the mower 100 in rolling engagement with the ground surface 107.

Although the illustrated mower has the drive wheels 106 in the rear and the caster wheels 108 in front, this configuration is not limiting. For example, other embodiments may reverse the location of the wheels, e.g., drive wheels in front and caster wheels in back. Moreover, other configurations may use different wheel configurations altogether, e.g., a tri-wheel configuration. Accordingly, other embodiments are possible without departing from the scope of the invention.

A cutting deck 114 (FIG. 1) may be mounted to the lower side of the frame 102 generally between the drive wheels 106 and the caster wheels 108. The cutting deck 114 includes one or more cutting blades (not shown), as known in the art, that are operatively powered by the engine 104. Miscellaneous controls 109 permit operator control of various mower functions, e.g., throttle, blade engagement, etc.

During operation, power is selectively delivered to the cutting deck 114 and drive wheels 106, whereby the cutting blades rotate at a speed sufficient to sever grass and other vegetation as the cutting deck 114 passes over the ground surface. Typically, the cutting deck 114 has an operator-selectable height-of-cut control 115 to allow adjustment of the cutting deck 114 height relative to the ground surface. The cutting deck 114 may optionally include deck rollers (not shown) to assist in supporting the cutting deck 114 relative to the ground surface during operation.

Other aspects/features of the mower 100 that are either not central to the invention or are readily known by those skilled in the art may also be included. However, such other aspects/features are not further discussed and/or illustrated herein.

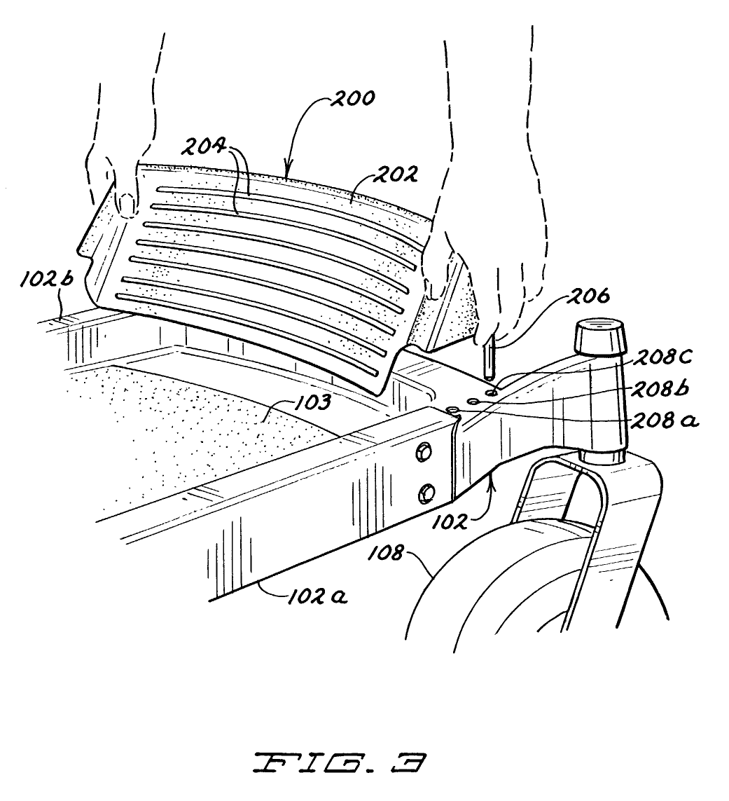

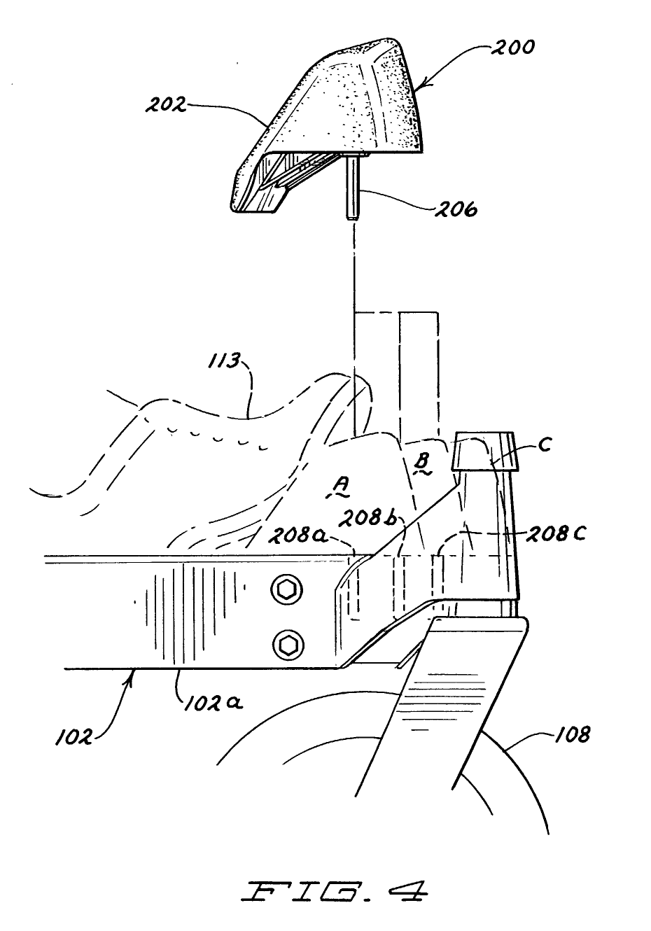

An adjustable footrest apparatus 200 in accordance with one embodiment of the present invention is also illustrated in FIGS. 1 and 2. The footrest apparatus 200 includes at least one footrest surface 202 (see FIG. 2) against which the operator 111 may place the bottoms of his or her feet 113 during operation as shown in FIG. 1. A substantial portion of the footrest surface 202 is preferably inclined relative to a horizontal plane, e.g., it slopes upwardly and forwardly from a floor 103 (see FIGS. 3 and 4) of the mower 100. While not limited to any particular configuration, the footrest surface 202 may, in one embodiment, extend substantially across a transverse width of the mower 100.

In one embodiment, the footrest surface 202 may be removably but substantially fixed to the mower 100 at multiple operator-selectable locations. For example, the footrest surface 202 may be attachable to the frame 102 at varying locations along a direction parallel to the longitudinal axis 117 (see FIG. 2) of the mower 100. As a result, the adjustable footrest apparatus 200 permits comfortable positioning of the feet 113 during operation regardless of the operator's size.

The term “footrest surface,” as used herein, may include most any surface on which the operator's feet may be rested during mower operation. While illustrated herein as a relatively flat and angled transverse surface, other embodiments may utilize a footrest apparatus having most any footrest surface shape. For example, the footrest surface may be a simple beam element, e.g., of cylindrical or rectangular cross-section, that provides generally line contact with the operator's feet. Other embodiments may incorporate multiple footrest surfaces, e.g., left and right surfaces, that may be moved together or independently of one another.

In addition to providing a comfortable foot position, the footrest surface 202 provides an inclined surface, e.g., a surface having a vertical component, against which the operator 111 may push when wishing to reposition himself or herself in the operator's seat 112. In addition to being inclined, the footrest surface 202 may, in some embodiments, be slightly curved from side-to-side, e.g., concave, to conform to the natural position of the operator's feet during operation (see FIG. 1). Stated another way, the shape of the footrest surface 202 may, in one embodiment, be substantially similar to a surface of a tilted cylinder. In other embodiments (not shown), the surface 202 may be more similar to a frustum, e.g., have a radius that varies from the top of the footrest surface 202 to the bottom like the surface of a cone. In still yet other embodiments, the footrest surface 202 may form a substantially planar surface (also not shown).

The position of the footrest apparatus 200 may, as described above, be adjusted relative to the frame 102 and, thus, to the seat 112. For instance, the operator may, if necessary, first adjust the position of the seat 112 (relative to the frame 102 and the drive control levers 110) so that the drive control levers 110 are within comfortable reach. For operators having legs that are shorter than average, the footrest apparatus 200 may be moved (relative to the frame 102) such that it is closer to a back surface 112b of the seat 112, e.g., distance 220 (FIG. 2) may be reduced. Likewise, for operators having legs that are longer than average, the footrest apparatus 200 may be moved along the frame 102 to a position away from the back 112b of the seat 112 e.g., the distance 220 may be increased.

FIGS. 3 and 4 illustrate the exemplary footrest apparatus 200 of FIGS. 1 and 2 in more detail. The footrest apparatus 200, as described above, includes the footrest surface 202 against which the operator may rest his or her feet. While not wishing to be bound to any specific material, the footrest apparatus 200 may, in one embodiment, be injection-molded plastic. The footrest surface 202 may include traction-enhancing elements and/or texturing features to improve grip and/or aesthetic appearance. For example, the footrest surface 202 may include ribs 204 protruding from the footrest surface 202 as illustrated in FIG. 3. Alternatively, a no-slip adhesive layer (not shown) may be included on the footrest surface 202. In fact, most any texturing technique may be used without departing from the scope of the invention.

The footrest apparatus 200 may further include one or more protrusions, e.g., pins 206, each of which is sized to fit within a receiving aperture 208 of the frame 102. The pins 206 may be secured to the footrest apparatus 200 by most any technique, e.g., threaded or interference fit. In the illustrated embodiment, the footrest apparatus 200 includes two pins 206, one proximate each outer edge of the footrest surface 202 (only the pin 206 and the corresponding apertures 208a, 208b, and 208c (collectively referred to herein as “apertures 208”) on the right side of mower 100 are shown in FIG. 3, but the left side is substantially a mirror image).

Each of the pins 206 may fit within one of the receiving apertures 208a, 208b, or 208c. For example, for an operator having average-sized legs, the footrest apparatus 200 may be positioned with each pin 206 in its respective aperture 208b (see FIG. 3) such that the footrest is at a median position “B” as shown in FIG. 4. To move the footrest apparatus 200 (relative the frame 102) toward the seat 112 to accommodate an operator having shorter legs, the footrest apparatus 200 may be removed from the mower 100 and then moved to position “A” of FIG. 4 where each pin 206 is placed in its respective aperture 208a. Likewise, to move the footrest apparatus 200 (relative to the frame 102) farther away from the seat 112 to accommodate an operator having longer legs, the footrest apparatus 200 may be moved to position “C” where each pin 206 is then located in its respective aperture 208c. As a result, the footrest apparatus 200 may be adjusted relative to the frame 102 and the seat 112 to accommodate operators of different size.

Preferably, the length of the pins 206 and the degree of clearance between the pins 206 and apertures 208 eliminate the need for additional positive retainment mechanisms to secure the pin to the mower frame 102. However, such mechanisms, e.g., cotter pins, spring loaded detents, may be used without departing from the scope of the invention. Moreover, the apertures 208 may include a bushing (not shown) where beneficial or appropriate to reduce wear or to maintain the desired tolerances.

While illustrated with three apertures 208, the mower 100 could be modified with more (or less) apertures 208 to accommodate a broader range of operators. Moreover, the footrest, in other embodiments, may utilize alternative mounting techniques to achieve adjustability. For instance, the pins 206 may be located on the mower frame 102 and the apertures 208 on the footrest apparatus 200. Alternatively, the footrest apparatus 200 could slide within a track of the frame 102 and be restrained in the desired position by most any method including, for example, friction locks or detents. In yet another embodiment, the footrest apparatus 200 could pivot about an axis, e.g., a transverse horizontal axis, of the frame 102. Such pivoting would potentially allow the position of at least the footrest surface 202 of the footrest apparatus 200 to be selectively moved, relative to the frame 102, in a direction parallel to the longitudinal axis of the mower 100.

Exemplary embodiments of the present invention are described above. Those skilled in the art will recognize that many embodiments are possible within the scope of the invention. Other variations, modifications, and combinations of the various parts and assemblies can certainly be made and still fall within the scope of the invention. Thus, the invention is limited only by the following claims, and equivalents thereto.

What is claimed is:

1. A zero-radius-turning riding vehicle, comprising:
a seat attached to a frame of the vehicle;
one or more controls associated with the vehicle and located proximate the seat, the one or more controls operable to control one or both of speed and direction of the vehicle; and
a footrest apparatus coupled to the frame and comprising at least one footrest surface, wherein a position of the at least one footrest surface is adjustable relative to the vehicle.

2. The vehicle of claim 1, wherein the position of the at least one footrest surface is adjustable relative to the vehicle at least along a direction parallel to a longitudinal axis of the vehicle.

3. The vehicle of claim 1, wherein a location of the seat is adjustable relative to the frame at least along a direction parallel to a longitudinal axis of the vehicle.

4. The vehicle of claim 1, wherein the at least one footrest surface extends substantially across a transverse width of the vehicle.

5. The vehicle of claim 1, wherein the footrest apparatus further comprises one or more protrusions operable to engage one or more receiving apertures in the frame.

6. A zero-radius-turning riding lawn mower, comprising:
a seat attached to a frame of the lawn mower;
one or more controls operatively coupled to the frame, the one or more controls operable to control one or both of speed and direction of the lawn mower; and
a footrest apparatus coupled to the frame and comprising at least one footrest surface, wherein a position of the at least one footrest surface is adjustable relative to the frame.

7. The lawn mower of claim 6, wherein the at least one footrest surface extends substantially across a transverse width of the lawn mower.

8. The lawn mower of claim 6, wherein the position of the at least one footrest surface is adjustable relative to the frame at least along a direction parallel to a longitudinal axis of the lawn mower.

9. The lawn mower of claim 6, wherein the seat is adjustable relative to the frame at least along a direction parallel to a longitudinal axis of the lawn mower.

10. The lawn mower of claim 6, wherein the footrest apparatus comprises one or more protrusions operable to engage two or more receiving apertures in the frame of the lawn mower.

11. A zero-radius-turning riding lawn mower, comprising:
a frame supported in rolling engagement with a ground surface;
an operator's seat attached to the frame;
one or more control levers operatively coupled to the frame, the one or more control levers operable to control one or both of speed and direction of the lawn mower relative to the ground surface; and
a footrest apparatus attachable to the frame at more than one location along a direction parallel to a longitudinal axis of the lawn mower.

12. The lawn mower of claim 11, wherein the footrest apparatus is attachable to the frame at two or more locations along the direction parallel to the longitudinal axis of the lawn mower.

13. The lawn mower of claim 11, wherein the footrest apparatus comprises at least one footrest surface.

14. The lawn mower of claim 11, wherein the footrest apparatus comprises at least one protrusion and the frame comprises an aperture to receive the at least one protrusion.

15. The lawn mower of claim 14, wherein the footrest apparatus comprises two protrusions and the frame comprises at least two receiving apertures.

16. The lawn mower of claim 11, wherein the footrest apparatus extends substantially across a transverse width of the frame.

17. A zero-radius-turning riding lawn mower, comprising:
a frame supported in rolling engagement with a ground surface;
a seat attached to the frame;
one or more control levers operatively coupled to the frame and positioned near the seat, the one or more control levers operable to control one or both of speed and direction of the lawn mower relative to the ground surface; and
at least one footrest surface operable to securely attach to the frame at two or more locations along a direction parallel to a longitudinal axis of the lawn mower.

18. The lawn mower of claim 17, wherein the at least one footrest surface extends substantially across a transverse width of the frame.

19. The lawn mower of claim 17, wherein a substantial portion of the at least one footrest surface is inclined relative to a horizontal plane.

20. The lawn mower of claim 17, wherein a portion of the at least one footrest surface comprises traction-enhancing elements.

21. The lawn mower of claim 20, wherein the traction-enhancing elements comprise ribs protruding from the at least one footrest surface.

22. The lawn mower of claim 21, wherein the ribs are integrally formed with the at least one footrest surface.

23. The lawn mower of claim 17, wherein the at least one footrest surface further comprises one or more pins.

24. The lawn mower of claim 23, wherein the frame comprises two or more apertures operable to receive the one or more pins.

25. The lawn mower of claim 24, wherein the two or more apertures are offset from one another along the direction parallel to the longitudinal axis of the lawn mower.

26. A zero-radius-turning riding lawn mower, comprising:
a seat attached to a frame of the lawn mower;
one or more controls operatively coupled to the frame, the one or more controls operable to control one or both of speed and direction of the lawn mower; and
a footrest apparatus comprising at least one footrest surface, wherein one or both of the footrest apparatus and the at least one footrest surface are removably attachable to the lawn mower.
